(19) United States
(12) Patent Application Publication
(10) Pub. No.: US 2014/0279367 A1
(43) Pub. Date: Sep. 18, 2014

(54) Method and System for Calculating and Utilizing Realized Spread in Financial Transactions

(71) Applicant: Integral Development Inc., Palo Alto, CA (US)

(72) Inventors: Vikas Srivastava, Palo Alto, CA (US); Patrick Barkhordarian, Los Altos Hills, CA (US); Michelle Yip Chen, San Mateo, CA (US)

(21) Appl. No.: 14/214,305

(22) Filed: Mar. 14, 2014

Related U.S. Application Data
(60) Provisional application No. 61/801,123, filed on Mar. 15, 2013.

(51) Int. Cl. G06Q 40/04

(52) U.S. Cl. CPC G06Q 40/04
USPC 705/37

(57) ABSTRACT

A system for generating and utilizing financial trading metrics, comprising: (i) a data-obtaining module configured to obtain raw financial trade data; (ii) a data-normalizing module, operatively connected to the data-obtaining module and configured to convert raw financial-trade data into normalized financial-trade data; and (iii) a metric-generating module, operatively connected to the data-normalizing module and configured to generate financial-trade metrics based on the normalized financial-trade data.

### CROSS-REFERENCE TO RELATED APPLICATIONS AND PRIORITY CLAIM

This application claims priority to U.S. provisional patent application No. 61/801,123, entitled “Method, System, and Apparatus For Calculating and Utilizing Realized Spread In Financial Transactions.” This application is related to, and incorporates herein in their entirety, the following provisional patent applications, all filed Mar. 15, 2013, having the titles and serial numbers: “Method, System, and Apparatus for Real-Time Benchmarking,” 61/790,657; “Method, System, and Apparatus for Generating and Facilitating the Application of Trading Algorithms Across a Multi-Source Liquidity Market,” 61/791,369; and “Method, System, and Apparatus for Generating and Operating a Swaps Trading Platform,” 61/794,585.

This application is also related to U.S. provisional patent application Ser. No. 61/747,698, filed Dec. 31, 2012, titled “Methods and Systems for Facilitating Financial Exchanges Between Liquidity Takers and Liquidity Providers.” In addition, this application is related to U.S. patent application Ser. No. 12/984,651, filed Jan. 5, 2011, titled “Systems and Methods for Conducting Financial Transactions,” which is a continuation of U.S. patent application Ser. No. 10/911,076, filed Aug. 3, 2004, titled “Systems and Methods of Conducting Financial Transactions,” which is a continuation-in-part of U.S. patent application Ser. No. 09/703,198 filed Oct. 31, 2000, titled “System and Method for Conducting Web-Based Financial Transactions in Capital Markets,” the entirety of all of which is hereby incorporated by reference. This application also incorporates in its entirety herein by reference each of: (i) U.S. provisional patent application Ser. No. 60/139,113 filed Jun. 14, 1999, titled “System and Method for an XML Vocabulary for Capital Markets”; (ii) U.S. provisional patent application Ser. No. 60/162,873 filed Nov. 1, 1999, titled “Method and Apparatus for Web-Based Management of Financial Risk and Pricing and Trading of Financial Products”; (iii) U.S. patent application Ser. No. 09/593,324 filed Jun. 13, 2000, titled “System and Method for Conducting Web-Based Financial Transactions in Capital Markets,” now U.S. Pat. No. 6,347,307; (iv) U.S. provisional patent application Ser. No. 61/035,655 filed Mar. 11, 2008, titled “System and Method for Conducting Web-Based Financial Transactions in Capital Markets”; and (v) U.S. patent application Ser. No. 12/402,370 filed Mar. 11, 2009, titled “System and Method for Conducting Web-Based Financial Transactions in Capital Markets.” Each of the foregoing is assigned to the assignee of the present invention.

### FIELD

The instant disclosure relates generally to realized spread and related analytics to create a flexible, expandable data mining platform covering data sources and trading relationships and, more specifically, to a method and system for calculating and utilizing a realized spread in financial transactions.

### BACKGROUND

In general, realized spread is twice the difference between the execution price and the mid-quote of the same liquidity provider, with a lag of t seconds after execution, multiplied by −1 for customer's sell orders. For example, the “5 seconds realized spread” is a realized spread with a lag of 5 seconds and the “2 minutes realized spread” is realized spread with a lag of two minutes. However, realized spread has not been applied in an organized, cohesive fashion to market makers and other interested participants to allow them to make informed decisions regarding trades.

For example, if party A executes a trade with party B described as (Buy EUR/USD at 1.3414) and 10 seconds later party B's rates are 1.4316/18, then party B (the Market Maker or MM) is said to have realized −6 pips (1 pip=0.0001×base currency). The market maker's mid price of 1.4317 is what it thinks is the fundamental price at that time (1.4317) and the execution price (1.3414) will be the MM's realized spread. The sign being negative shows that the price has gone against the MM and when positive, it shows the MM benefited from the trade. As another example, if party C executes a (Sell EUR/USD at 1.3414) and 2 minutes later the same MM's rate is 1.4320/22, then the MM's realized spread is (−1)*2*(−7)=14 with the sign being positive. The MM benefited from executing the trade 2 minutes ago with party A. At the same time, party A did not benefit (if the trader could have possibly waited a couple of minutes before the sell trade) since the prices went up after the sell. In general, when the realized spreads are positive, MM will be happy to have executed the trade.

### BRIEF DESCRIPTION OF THE FIGURES

Reference will now be made to the accompanying figures and flow diagrams, which are not necessarily drawn to scale, and in which:

FIG. 1 is a block diagram illustrating one example of a computing device suitable for use in a method and system for calculating and using a realize spread in financial transactions, in accordance with this disclosure.

FIG. 2 is a block diagram of functional elements, in accordance with one embodiment the disclosure, illustrating the flow of information amongst the functional elements.

FIG. 3 is a flow chart of a method, in accordance with one embodiment the disclosure, illustrating steps for generating operational intelligence.

FIG. 4 is a flow chart of a method, in accordance with one embodiment the disclosure, illustrating additional steps for checking generated operational intelligence data for errors.

FIG. 5 is a flow chart of a method, in accordance with one embodiment the disclosure, illustrating additional steps for checking generated operational intelligence data for outliers and dispositioning the outliers.

FIG. 6 is a flow chart of a method, in accordance with one embodiment the disclosure, illustrating additional steps for calculating realized spread.

### DETAILED DESCRIPTION

To facilitate an understanding of the principals and features of the disclosed technology, illustrative embodiments are explained below. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

It must also be noted that, as used in the specification and the appended claims, the singular forms “a,” “an” and “the” include plural referents unless the context clearly dictates otherwise.

By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

It is also to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

The instant disclosure describes a method and system for calculating and utilizing a realized spread in financial transactions. The invention allows for provider to present customers with derived foreign exchange (“FX”) metrics that will enhance their trading returns via cost optimizations, enhanced liquidity access, improved fill ratios and transaction cost analysis.

The results of these analyses are presented to the customer both in real time and as a post-trading summary report. This allows MMs to classify any given relationship (flows) and/or markets as a whole, to facilitate real time trading. A MM is thus enabled to make business decisions based on these analyses. For example, a MM may adjust its quoted spread based on the analysis of realized spreads by applying a fractional pip when there are considerable occurrences (e.g. more than 75%) of negative realized spreads. Without this functionality, the MM would wait for an extended period of time before discovering the losses and then cease to do business with that customer. In particular, MMs may use the realized spread and related data generated by the analytic platform described herein to make better and more expedient decisions on trades thereby increasing profit and diminishing loss.

The analytic platform can also be used to improve customer experience and value. Large amounts of FX data are collected, from many sources, comprising the vast majority of the FX market place quotes. Trade events are also archived when initiated by customers. Such events may be utilized by those customers for price improvement and transaction cost analysis. Such data related to the realized spread may also be provided as logistics to additional consumers to be utilized in trading.

The FX markets are fragmented because currencies are traded over the counter (OTC), rather than in an organized exchange. At any given time, a trader is seeing multiple markets whose prices are changing based on who is trading in that venue and the connections that venue has to other venues under the control of that venue's provider. In this manner, each market maker's stream is considered a different market by itself. In this sense, a large bank is a different venue market than the smaller trader or any other stream from a market maker. There is no NBBO (National Best Bid and Offer) in the FX markets. If it is decided that, for a given trader, the NBBO should be defined based on the best prices offered to that trader (based on what's provisioned for that trader), this data can be utilized to improve the efficiency, expediency, and profitability of such trades. As an additional example, FXGid-BBO is defined as the absolute best price (BO) available within FX grid at the time of trade. Any number of measures for the quality of execution or liquidity can be generated from the spread data using the analytics disclosed herein. Such analytics facilitate the trader to make the most profitable, expedient trades possible or, possibly more important, to decide not to trade with that entity at all.

The present method and system for calculating and utilizing a realized spread in financial transactions creates, in part, a Positive Network Externality (PNE) on the MM side. As more market makers provide liquidity to the same customer, each market maker becomes more concerned about how it will profit from market making. This is an inherent Negative Network Externality (NNE). The NNE must be offset by the PNE crossing from the takers to the makers (meaning there are enough takers that a market maker desires to trade). Having more takers is better, i.e., it creates a cross-side PNE. However, after a market maker neutralizes the same-side NNE via the cross-side PNE, a same-side PNE must be created on the MM side to maximize profitability. This PNE is created by utilizing the analytical methods herein, related to realized spread and other market factors, so that the MM can improve their pricing and improve their share of the customers' business.

This data, combined with classification of how the majority of deals are getting done, allows the MM to determine how to achieve more flow (i.e. transaction volume) by focusing on the quoted spread for a given market, a given day, a given week, a given customer, etc. A MM may be successful in deals for many combinations of reasons. For example, the MM may have: (1) price priority and the lowest MM quoted spread (most aggressive, lowest cost provider); (2) price priority but not the lowest MM quoted spread (smartest provider but clearly not the lowest cost provider); (3) time priority and the lowest MM quoted spread (most aggressive, fastest, and lowest costs provider); or (4) time priority but not the lowest MM quoted spread (fastest and smartest, but not the lowest cost provider. A MM who lost execution to another MM, may gain insight into increasing flow, by using the disclosure. For example, if a MM lost a buyer-initiated execution because it had worse price priority, despite the MM offering the lowest quoted spread, it may be because the MM is pricing badly on that side.

By adding “realized spreads” to the actual spread, as made possible by this method and system for calculating and utilizing a realized spread in financial transactions, the MM can now separate good customer flow from median customer flow and bad customer flow, thereby classifying the customers. Combining actual and realized spread in the direct trading environment reduces the MM's search costs to find the right customer flow. This also applies in instances with FX anonymous flow in transparent relationships where the MM is seeking customized flow that generates positive realized spread, despite a Prime Broker (“PB”) hiding the identity of the other side.

As an additional example, if a MM is offered (A) an anonymous counterpar (trading via a PB) who generates a positive MM's realized spread in 75% of its trading activities (i.e. liquidity trader) as compared to (B) a transparent CPTY who is almost always generating MM's negative realized spreads (i.e. informed trader) the MM may chose (A) over (B) only if the information transparency exists to pre-qualify that customer flow. Qualifying trading opportunities with the right level of information transparency informs the MM how to do to gain more of a particular (i.e. desirable) type of business. As another example, if a MM knows that certain liquidity traders do business with various other MM's having a 2 pips in quoted spread, the MM will pay more to make markets with those liquidity traders than with other, lower-margin liquidity traders who are already matched with other aggressive, low cost, market makers. In general, for Over the Counter (OTC) markets, unlike exchanged traded securities, the value of market data, including realized and actual spread, or “information transparency,” presented using the techniques of this disclosure is directly related to these “search costs” incurred by MM's to ensure profitability, safety, and longevity of trading relationships.

Examples of specific metrics and operational intelligence reports are provided below.

### Single Trade, Single Time Point Price Improvement

This metric displays the prices available to the trader from a list of liquidity providers at a specific time (‘MarketTime’) for purposes of comparing an actual trade with a trade optimized for price across a different set of liquidity partners.

For example, the query input parameters may comprise what prices were available at a certain time from users for USD/JPY:

TABLE 1

| Name | Units | Example | Description |
|---|---|---|---|
| Currency Pair | String | USD/JPY | Dollar, Yen |
| Side | Buy \| Sell | Buy | Side of trade |
| Date | Yyyymmdd | 20100314 | Mar. 14, 2010 |
| Market Time | Hhmmss | 94232.455 | 9:42:32 AM and 455 |
| | | | msecs |
| Liquidity | String | Providers | Identifiers for |
| Providers | | | liquidity providers |

In the same example, the query results are displayed highlighting the best bid and best offer across all liquidity providers:

TABLE 2

| Liq | Avg Bid | Best Bid | Best Ask | Avg Ask |
|---|---|---|---|---|
| Provider | Size | Price | Price | Size |
| DB2 | 1 mm | 93.454 | 93.461 | 1 mm |
| HSFX | 5 mm | 93.459 | 93.464 | 3 mm |
| JPMB | 20 mm | 93.448 | 93.454 | 20 mm |

### Single Trade, Extended Time Frame Price Improvement.

Another embodiment, extending the example above, determines the maximum price optimization, if any, for a given trade over a time period starting at ‘OrderTime’ and extending for ‘OrderDuration’. The query returns the actual and optimized PnL (Profit and Loss) for the trade:

For example, the query input parameters may comprise:

TABLE 3

| Name | Units | Example | Description |
|---|---|---|---|
| Currency Pair | String | USD/JPY | Dollar, Yen |
| Side | Buy \| Sell | Buy | Side of trade |
| Size | Base | 1 mm | Transaction size in |
| | Currency | | units of base currency |
| Date | Yyyymmdd | 20100314 | Mar. 14, 2020 |
| Order Time | Hhmmss | 94232.455 | 9:42:32 AM and 455 |
| | | | msecs |
| Order Duration | Seconds | 300 | Duration over which to |
| | | | test price optimization |
| Transaction | String | DB2 | Liquidity provider used |
| Liquidity | | | in actual trade |
| Provider | | | |

For the same example, the query output may comprise:

TABLE 4

| | Actual Trade | Optimized Trade |
|---|---|---|
| Timestamp | 9:43:00.455 | 9:43:24.866 |
| Ingress Transaction Price | 93.54 | 93.48 |
| Egress Transaction Price | 93.72 | 93.74 |
| Ingress Liquidity Provider | Provider 1 | Provider 2 |
| Egress Liquidity Provider | Provider 1 | Provider 3 |
| PnL | $1800 | $2600 |

In this example, the query output would be interpreted such that the optimized trade would have been to buy 1 mm USD/JPY at 93.54 at 9:43.

### Multiple Trade Price Improvement

Another embodiment analyzes a list of actual trades in the database to determine what selection of liquidity providers and order duration would have optimized profit and loss (PnL).

In this embodiment, the query input comprises a list of elements in Table 4 with the addition of a Liquidity Provider filter (i.e. a list of liquidity providers to be considered for each trade). If potential liquidity providers are not specified, the query checks all of available liquidity providers for each transaction. If the query includes an order duration, it will look ahead to determine the magnitude of price improvement that could have been achieved over that time period.

The query output of this embodiment comprises two tables: one that compares actual with optimized trades, and another that lists liquidity providers that were used to execute the optimized trades, sorted by the number of trades executed by each provider. This allows the trader to see which liquidity providers would have been optimal for their trading models. In cases where price improvement is found, PnL and LP cells are displayed in bold.

TABLE 5

| | Trade | Actual | Actual | Potential | Optimized |
|---|---|---|---|---|---|
| Side | Time | LP | PnL | PnL | LP |
| LONG | 9:51:15 | Provider 1 | 165.32 | 165.32 | Provider 1 |
| LONG | 10:12:47 | Provider 1 | 86.32 | 113.12 | Provider 2 |
| SHORT | 10:51.06 | Provider 1 | −112.08 | −110.66 | Provider 2 |
| LONG | 11:14:27 | Provider 1 | 43.77 | 56.88 | Provider 3 |

Additionally, the tally of PnL differences and ranked list of liquidity providers is provided.

TABLE 6

| Trade | Improvement | | | |
|---|---|---|---|---|
| count | Count | Actual PnL | Potential PnL | Delta |
| 47 | 16 (35%) | $1766.77 | $2145.44 | $378.67 |

### Realized Spread Analysis

In another embodiment, the average realized spread is calculated at fixed time points following trade events, on a per customer and per liquidity provider basis. In this embodiment, the query input may include:

TABLE 7

| | Units | Description |
|---|---|---|
| Start Day | 20100314 | YYYYMMDD for start of time period |
| End Day | 20100331 | YYYYMMDD for end of time period |
| Currency Pair | Name | Identifier for currency pair (eg. |
| | | USD/JPY |
| Liquidity Provider | Provider 1 | Single liquidity provider trading partner. |
| Interval Schedule | Seconds | Values for T1, T2, . . . Tn (eg. 5, 30, |
| | | 60, 120 seconds after ingress trade) |

In this embodiment, for each trade event, the query results comprise a report, in pips, of the spread value at time, T(n), where the sign of the spread is based on the profitability of the trade at that time. If the trade is going against the party then the realized spread becomes a larger negative number (e.g. the first data row below).

TABLE 8

| Trade Event | T0 (0) | T1 (5) | T2 (30) | T3 (60) | T4 (120) |
|---|---|---|---|---|---|
| 9:32:43.322 | −0.56 | −0.78 | −0.82 | −0.91 | −1.23 |
| 9:38:32.004 | −0.51 | −0.12 | −0.03 | 0.34 | 0.56 |
| 9:49:43.411 | −0.42 | 0.02 | 0.12 | 0.34 | 0.81 |
| 9:53:12.034 | −0.53 | 0.06 | 3.21 | 0.32 | 0.56 |
| 10:03:44.533 | −0.62 | −1.33 | −0.87 | 0.12 | 2.10 |
| 10:07:12.688 | −0.33 | 0.12 | −0.03 | 0.34 | 1.56 |

### Order Fill Analysis:

Another embodiment generates a trading report comparing actual order-fill ratios to potential order-fill ratios for a given collection of liquidity providers. The potential order-fill ratio is generated by analyzing the cases where a MM was not the best destination for execution. For example, a MM may have been the second best destination for execution (either 2nd best for price or time priority). The order-fill analysis determines a performance improvement, for example being an average of “n” milliseconds faster (becoming best in time priority), and determines how much more order flow the MM would have achieved. The order-fill analysis would function similarly for the price priority, analyzing the MM's price spread.

### Liquidity Provider Termination Risk

Another embodiment informs traders that their pattern of trading with a particular liquidity provider may result in termination based on that liquidity provider's past termination profile. For example, a machining learning algorithm would generate, from available network-provisioning data, a list of traders having similar realized spreads and volume of orders with a particular MM, who were terminated within a particular time frame. Traders who value transactions with particular MMs can then adjust their positions to avoid termination by the valued MMs.

What MMs look for when they trade with a taker is to make money from the spreads as they internalize the customers' buy and sell orders. A taker is viewed as a liquidity trader if her trades have a 50% chance of having positive realized spreads and 50% of having negative realized spreads. Here, the term “liquidity” trader is used to mean that this trader is serving its real customers' needs for FX as opposed to trading in and out of his positions to gain money based on his FX price speculations. Similarly, if a trader is generating a negative 5-seconds realized spreads for the MM in 95% of the times executing a large number of trades, that trader is most likely involved in taking advantage of various systems' latency (so called latency arbitrage or parasitic trading activities). Obviously, the MMs are looking for the liquidity traders and generally try to avoid the latency arbitrageurs. Furthermore, if a trader is always generating a positive 10-seconds spread but a negative 30-minutes spread, that trader is a good momentum trader and still desirable by the MMs with sufficiently large customer flow or access to other electronic trading systems in order to automatically take advantage of the positive short-term (10-seconds) gains (realized spreads), before they turn negative (in 30 minutes).

Application of the system analytics described herein determines whether or not the MM gains a positive realized spread (MM Wins), a negative one (MM Loses) or a zero realized spread (Draw). Stated differently, aside from the actual spreads and the dealt amount delta due to the spread, as economic data, the disclosure provides a view of win/loss or draw between the MM and the trader for each executed trade.

Given a collection of actual trades, and considering 10-seconds after the trades were executed, the study of win/loss/draw can indicate, for example, how many times the MMs were on the winning side or losing side for a single trader, a group of traders, or all traders active in the market. Further examination of the same collection of trades can pinpoint traders who are often considered the winner (in more than 75% of the times) and will likely be undesirable counterparties for a MM because they do not behave like liquidity traders.

### Customer Flow Analysis Reports

In exemplary embodiment, the method and system described herein provide for the generation of one or more customer flow analysis report(s). Customer flow analysis reports display the behavior of the benchmark stream after each customer trade. These reports allow users to analyze the quality of flow for each of the hub customers. If the benchmark moves in the direction in favor of the customer's trade (i.e. rate goes up after a customer buys, and vice versa), the customer is considered an “informed trader,” and hence, potentially not a desirable flow for the hub. The observations are done in a number of time intervals (e.g. 6 time intervals). Continuing with the 6 time interval example, these intervals may include: (1) immediately after the trade; (2) 5 seconds after the trade, (3) 10 seconds after the trade; (4) 15 seconds after the trade; (5) 30 seconds after the trade; and (6) 60 seconds after the trade.

In one example, an exemplary customer flow analysis report includes two (2) worksheets: (1) a “Mid-Mid Changes” worksheet that analyzes the benchmark movement in mid prices (e.g. a worksheet that compares mid price at time (0) vs. mid price at time (x)); and (2) a “Full Spread Changes” worksheet that analyzes the cost for an LP to cover a trade based on the changes in the benchmark stream (e.g. if customer is buying, it compares ask price at time (0) vs. bid price at time (x)).

Further, an exemplary customer flow analysis report may include a variety of charts. In one example, the charts are from the liquidity provider's point of view where positive $ per million indicates an LP gains, and vice versa. Exemplary charts are as follows: (1) the “Average mid price/full spread change” chart shows how the mid price/full spread changes, in $ per million, for the selected customers over different time intervals; (2) the “Percentage of good flow” chart shows the percentage of the time the customer's flow is considered a good flow for the LP (i.e. the market moved in the direction against the customer); (3) the “Mid price/full spread change from 0 to 15 seconds” is optimal for viewing only a single selected customer; it shows how the mid price/full spread changes, in $ per million, from the trade to 15 seconds after the trade over the selected dates; and (4) the “Average mid price/full spread change from 0 to 15 seconds” chart is optimized for viewing a group of customers; it displays a ranking of the customers from good flow to bad flow, showing on average how much $ per million an LP gains/loses 15 seconds after the customer trades.

### Additional Exemplary Techniques, Features and Applications

One exemplary study of the 10-seconds realized spreads using the analytical system examined 2842 executed trades, considering all takers as a group. The study revealed that in 1721 trades, or 60% of all trades, the MMs won (generated a positive 10-seconds realized spreads), while in 621 trades (22% of all trades) the MMs lost some realized spreads. The rest of the time (in 17% of all trades) there was a draw.

The 2-minutes realized spreads of the same 2842 trades, considering all takers as a group, revealed that MMs-win in 53%, draw in 10%, and MMs-lose in 36% of the times. Considering the 30-minutes realized spread, the figures become 48%, 3% and 47% for MM win, draw, and lose respectively. There is a relationship between the closeness of the realized spreads, the quoted spreads, and the robustness of the market's liquidity. For example, there are several studies that compare such relationships in between the NYSE and NASDAQ. These studies show that the statistical measure of the 5-minutes realized spreads in NYSE is closer to that market's quoted spreads, whereas the same statistical measures for NASDQ show a greater difference between its 5 minutes realized spreads and its quoted spreads.

Theoretically, when statistical measures of the realized spreads and quoted spreads are very close, all traders would prefer that market because trades executed in such a market are not changing the prices (less information leakage in that market), which is a very important aspect of liquidity quality in a given market. This statistic, sometimes called market resiliency, is often referred to as the measure of the robustness of the market's liquidity. In performing such analysis, one can perform comparative analysis (comparing the robustness of the entire FX market as a market with any single MM's market) and temporal analysis (comparing the robustness of the entire FX market as a market in various quarters of a year).

There is also another kind of spread called the “effective spread” which is the “actual” spread charged to a customer at the time of execution. In one popular FX trading platform, the effective spreads are always equal to the quoted spreads. However, in a system delivered by another FX trading platform, there may be a difference between the quoted spreads and the effective spreads (due to the brokers' benefits from price improvements). In systems that allow executions such that the counter-party's effective spreads can be statistically measured relative to the quoted spreads, a whole new class of analysis then becomes possible.

System infrastructure is enumerated below as hardware and software infrastructure requirements. The enumerated requirements support the long term algorithmic and data scalability supporting the MM portals incorporating the method and system for calculating and using a realize spread in financial transactions. This includes analyzing desired time slices (2 ticks, 10-seconds, 2-minutes) to gain desired information regarding the flow they are receiving.

In one example the data, data access, data storage requirements, hardware infrastructure and software infrastructure requirements includes:

Data Description
i. Trade Event: trade event defined as the collection of fill events linked to a single trade request by customer.
   1. Timestamp
   2. Customer_id
   3. Side
   4. Request_price
   5. Average_fill_price
   6. Lapsed_time_to_fill
   7. Order resolution (filled, partial, canceled, etc.)
ii. Fill events are the list of market transactions that satisfy the trade request. The fields include:
   1. timestamp,
   2. customer id,
   3. liquidity_provider_id,
   4. side, (buy or sell)
   5. transaction_price,
   6. transaction_size,
   7. quote_proximity (trade price proximity to best bid and best ask prices)
iii. Quote Book Event: Each updated quote from each liquidity provider includes the following fields:
   1. timestamp,
   2. liquidity_provider_id,
   3. side (bid or ask),
   4. order book level,
   5. size,
   6. price,
   7. price_improvement (+ or −),
   8. lapsed_time (since last update for this liquidity provider),

b. Data Access Requirements
i. Programmatic DB-style queries to retrieve data.
ii. Selections based on ETL-style queries, including filtering return data
iii. High speed access to large data sets looking back up to several years.
iv. Ability to filter on specific columns

c. Data Storage Requirements
i. Multiple terabytes.
ii. Distributed storage in order that one large data query does not impact other concurrent queries.
iii. Access independent of modeling OS and hardware

d. Quote to Trade

e. Timestamping is constructed using atomic clocks and precision time protocol to assure that incoming data from different sources is synchronously time-stamped at 10 microsecond b resolution

Hardware Infrastructure Requirements

a. Large capacity, fast access large storage system
i. Distributed File System
ii. Network Accessible Storage (NAS)
iii. Hadoop Distributed File System (file access model)
iv. Hadoop MapReduce functionality (distributed data access model)

b. Cluster compatible CPU arrangement
i. Support for bulk data queries
ii. Support for customer-defined queries
iii. Support for distributed calculation methodologies (parallel processing)

c. Support for Customer Queries (web service?)
i. Larger or non-real-time queries to run as lower priority.

d. Support for real-time trading decision support

i. Metrics calculated and delivered to customer consoles.

Software Infrastructure Requirements

a. Requirements
i. Column-based Data Access
ii. MapReduce programming
iii. Financial Analytic Libraries
iv. Statistical Analysis Software Packages

b. Java for MapReduce programming
i. MapReduce programming is also supported in Perl, C++, Python, Ruby

c. R statistical framework

d. QuantLib library

e. GSL (Gnu Scientific Library)

Referring now to the Figures, in which like reference numerals represent like parts, various embodiments of the computing devices and methods will be disclosed in detail. FIG. 1 is a block diagram illustrating one example of a computing device 100 suitable for use in a method and system for calculating and using a realize spread in financial transactions.

FIG. 1 illustrates a representative computing device 100 that may be used to implement the teachings of the instant disclosure. The device 100 includes one or more processors 102 operatively connected to a storage component 104. The storage component 104, in turn, includes stored executable instructions 116 and data 118. In an embodiment, the processor(s) 102 may include one or more of a microprocessor, microcontroller, digital signal processor, co-processor or the like or combinations thereof capable of executing the stored instructions 116 and operating upon the stored data 118. Likewise, the storage component 104 may include one or more devices such as volatile or nonvolatile memory including but not limited to random access memory (RAM) or read only memory (ROM). Further still, the storage component 104 may be embodied in a variety of forms, such as a hard drive, optical disc drive, floppy disc drive, flash memory, etc. Processor and storage arrangements of the types illustrated in FIG. 1 are well known to those having ordinary skill in the art. In one embodiment, the processing techniques described herein are implemented as a combination of executable instructions and data within the storage component 104.

As shown, the computing device 100 may include one or more user input devices 106, a display 108, a peripheral interface 110, other output devices 112, and a network interface 114 in communication with the processor(s) 102. The user input device 106 may include any mechanism for providing user input to the processor(s) 102. For example, the user input device 106 may include a keyboard, a mouse, a touch screen, microphone and suitable voice recognition application, or any other means whereby a user of the device 100 may provide input data to the processor(s) 102. The display 108 may include any conventional display mechanism such as a cathode ray tube (CRT), flat panel display, or any other display mechanism known to those having ordinary skill in the art. In an embodiment, the display 108, in conjunction with suitable stored instructions 116, may be used to implement a graphical user interface. Implementation of a graphical user interface in this manner is well known to those having ordinary skill in the art. The peripheral interface 110 may include the hardware, firmware and/or software necessary for communication with various peripheral devices, such as media drives (e.g. magnetic disk or optical disk drives), other processing devices, or any other input source used in connection with the instant techniques. Likewise, the other output device(s) 112 may optionally include similar media drive mechanisms, other processing devices, or other output destinations capable of providing information to a user of the device 100, such as speakers, LEDs, tactile outputs, etc. Finally, the network interface 114 may include hardware, firmware, and/or software that allows the processor(s) 102 to communicate with other devices via wired or wireless networks, whether local or wide area, private or public, as known in the art. For example, such networks may include the World Wide Web or Internet, or private enterprise networks, as known in the art.

While the computing device 100 has been described as one form for implementing the techniques described herein, those having ordinary skill in the art will appreciate that other, functionally equivalent techniques may be employed. For example, as known in the art, some or all of the functionality implemented via executable instructions may also be implemented using firmware and/or hardware devices such as application specific integrated circuits (ASICs), programmable logic arrays, state machines, etc. Furthermore, other implementations of the device 100 may include a greater or lesser number of components than those illustrated. Once again, those of ordinary skill in the art will appreciate the wide number of variations that may be used is this manner. Further still, although a single computing device 100 is illustrated in FIG. 1, it is understood that a combination of such computing devices may be configured to operate in conjunction (for example, using known networking techniques) to implement the teachings of the instant disclosure.

FIG. 2 is a block diagram illustrating a system 200 comprising an exemplary embodiment of the disclosure. The system comprises a plurality of logic modules, one or more databases, data storage, and a meta-data model. The plurality of logic modules includes, at minimum, a data-obtaining module 202, a data-normalizing module 204, a metric-generating module 206, and an intelligence-generating module 208. The logic modules may comprise hardware or software, or a combination of both. Similarly, the logic modules may reside on a single computing device or they may be distributed among a plurality of computing devices.

The system further comprises data storage 220, a meta-data model 212, and a normalized database 214. The data-obtaining module 202 is operatively connected to the data-normalizing module 204 and the data storage 220. The data-obtaining module 202 is also operatively connected to at least one source of raw data. The raw data sources may include a log server 210 or a reporting database 216. A log server, for example, may capture (“log”) all events on the trading platform while the reporting database may be the structure repository for that data.

The data-normalizing module 204 is operatively connected to the data-obtaining module 202, the data storage 220, the meta-data model 212, the metric-generating module 206, and the intelligence-generating module 208. The metric-generating module 206 is operatively connected to the data-normalizing module 204 and the normalized data database 214.

In operation, the data-obtaining module 202 may obtain raw financial-trade data 240 from a log server 210 via an http listing query 260. The data-obtaining module 202 may also obtain raw financial-trade data 240 from a reporting database 216 via an extract, transfer, and load mechanism (ETL) dump 262 of the reporting database 216. The data-obtaining module 202 may also obtain raw financial-trade data 240 from those sources or from another source by executing an http request under programmatic control 264. The data-obtaining module 202 then writes the raw financial-trade data 240 to the data storage 212. The data-obtaining module 202 also notifies 242 the data-normalizing module 204 that raw financial trade data 240 is available in the data storage 220 to be normalized.

After being notified 242 that raw financial-trade data is available in data storage 220, the data-normalizing module will retrieve the raw financial-trade data 240 and process it. Processing the raw financial-trade data 240 comprises extracting individual trade data 244 from raw financial-trade data, converting the raw financial-trade data to binary format, and storing the normalized binary financial-trade data 248 in the normalized-data database 214. The individual trade data 244 extracted from the individual records of raw financial-trade data includes, but is not limited to, a Globally Unique Identifier (GUID) for the quote, a Counter-Party Identified (CPID), date of the trade (YMD), time of the trade (HMS), price of the trade, and the size of the trade. The data-normalizing module 204 then updates the meta-data model 212 with the individual trade data 244 and notifies 246 the metric-generating module 206 that normalized binary financial-trade data 248 is available in the normalized-data database 214 and that the meta-data model 214 has been updated with individual trade data 244. A person skilled in the art will recognize that the normalized data may reside in the same database as the calculated metrics. The same holds for the generated operating intelligence.

The metric-generating module 206 then generates metrics 250 relating to individual trades. The metrics 250 may include, but are not limited to, realized spread, effective spread, and other metrics derived from these measures. The metric-generating module 206 also aggregates metrics according the counterparties involved, by individual trader, by liquidity provider, by subsequent market changes, by trade classification, and according to performance. The individual trade and quote metrics 266 and aggregated trade and quote metrics 268 are then stored in the normalized data database 214.

In another embodiment, the disclosure may additionally include an intelligence-generating module 208. The intelligence-generating module 208 is operatively connected to the metric-generating module 206, the meta-data model 212, and the normalized data database 214. Upon a query by a user, the intelligence-generating module 208 obtains data-structure information 266 from the meta-data model and aggregated trade and quote metrics 268 from the normalized data database 214. The intelligence-generating module 208 then generates operational intelligence and communicates the operational intelligence to the user. Operational intelligence may include, but is not limited to: effective spreads, profitability, liquidity provider resiliency, and informed trader rankings.

FIG. 3 illustrates another exemplary embodiment comprising a method for generating a operational intelligence. At step 302, one or more raw data files are obtained from a reporting database or a log server. Raw data files may be obtained from the database via a ETL dump. Raw data files may also be obtained from the log server via an http file listing query. Raw data files may also be obtained from the log server, the reporting database, or another source via an http request under programmatic control. At step 304, the raw data may be compressed. At step 306, the raw data files are stored. At step 310, the raw data files are normalized, as described above. At step 312, the meta-data model is updated as described above. At step 314, basic metrics are generated as described above. At step 316, the basic metrics are stored in the normalized data database as described above. At step 318, operational intelligence is generated based on the basic metrics as described above.

FIG. 4 illustrates another exemplary embodiment. This further embodiment comprises the method 300 of FIG. 3 and further comprises the step 400 of identifying errors in the basic metrics or the operational intelligence.

FIG. 5 illustrates another exemplary embodiment. This further embodiment comprises the method 300 of FIG. 3 and further comprises the step 500 of identifying outliers in the basic metrics or the operational intelligence. At step 502, if no outliers have been found, the method is complete 510. If outliers have been found, step 504 checks the system settings and determines how to handle them. Depending on the system settings, the outliers are either flagged 506 or discarded 508.

FIG. 6 illustrates one specific embodiment of generating operational intelligence 318, from FIG. 3. At step 600 the type of realized spread to generate is determined. Possible types include, but are not limited to, spread capture 602, no spread 604, and midpoint spread 606. At step 608, the point of view of the trader is determined, i.e. whether, for a given trade, was the trader in question buying of selling.

At step 614, the spread capture for a selling trader is calculated by subtracting the executed trade price from the forward offer. At step 616, the spread capture for a buying trader is calculated by subtracting the forward bid from the executed trade price. At step 618, the no spread for a selling trader is calculated by subtracting the executed trade price from the forward bid. At step 620, the no spread for a buying trader is calculated by subtracting the forward offer from the executed trade price. At step 622, the midpoint spread for a selling trader is calculated by subtracting the executed trade price from the midpoint between the bid and the offer. At step 624, the midpoint spread for a buying trader is calculated by subtracting the midpoint between the bid and the offer from the executed trade price.

A person skilled in the art will understand that the above method may be implemented via a non-transitory computer-readable medium comprising executable instructions configured to cause one or more processing units to execute any or all of the above steps.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component or module. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments of this technology are described above with reference to block and flow diagrams of computing devices and methods and/or computer program products according to example embodiments of the disclosure. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the disclosure.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments of this disclosure may provide for a computer program product, comprising a computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for generating and utilizing financial trading metrics, comprising:
a data-obtaining module configured to obtain raw financial trade data;
a data-normalizing module, operatively connected to the data-obtaining module and configured to convert the raw financial-trade data into normalized financial-trade data;
a metric-generating module, operatively connected to the data-normalizing module and configured to generate financial-trade metrics based on the normalized financial-trade data.

2. The system of claim 1, wherein one of the generated financial-trade metrics comprises effective spread.

3. The system of 1 wherein one of the generated financial-trade metrics generated comprises a realized spread.

4. The system of claim 1, wherein the metric-generating module is configured to generate the financial-trade metrics by calculating a realized spread, and wherein calculating a realized spread comprises at least one of:
subtracting an executed trade price from a forward offer;
subtracting a forward bid from the executed trade price;
subtracting the forward bid from the executed trade price;
subtracting the executed trade price from the forward bid;
subtracting the forward offer from the executed trade price;
subtracting the executed trade price from a midpoint between a bid and an offer; and
subtracting the midpoint between the bid and the offer from the executed trade price.

5. The system of claim 4, wherein the realized spread is calculated relative to a fixed time following a trade.

6. The system of claim 4, wherein the metric-generating module is further configured to:
automatically adjust a quoted spread, based on the realized spread.

7. The system of claim 1, wherein the metric-generating module is further configured to:
generate the financial-trade metrics for one or more discrete lag times.

8. The system of claim 1, wherein the financial-trade metrics comprises the prices available to the trader from a list of liquidity providers at a specific time.

9. The system of claim 1, further comprising an intelligence-generating module operatively connected to the metric-generating module and configured to generate operational intelligence data based on the financial-trade metrics.

10. The system of claim 9, wherein operational intelligence data comprises a report comparing an actual trade with a trade optimized price, across a set of liquidity partners.

11. The system of claim 9, wherein the intelligence-generating module is further configured to:
calculate an actual profit or loss for a trade, wherein the trade has a known execution price;
determine an optimum price for the trade within a specified time period; and
generate an optimized profit or loss for the trade based on the known execution price and the optimum price.

12. The system of claim 9, further wherein the intelligence-generating module is further configured to:
determine, based on the financial-trade metrics, one or more profit conditions under which profit may arise from acting as an execution intermediary between one or more liquidity providers and one or more traders; and
generate a potential profit margin from acting as an execution intermediary between the one or more liquidity providers and the one or more traders, based on the profit conditions and the financial-trade metrics.

13. The system of claim 9, wherein operational intelligence data comprises at least one of:
an actual order-fill ratio;
a potential order-fill ratio; and
a comparison of the actual order-fill ratio and the potential order-fill ratio.

14. The system of claim 9, wherein operational intelligence data comprises termination likelihood information, wherein the termination likelihood information comprises an estimate of the likelihood that one or more liquidity providers will terminate transactions with the trader, based on the trader's prior trades and the one or more liquidity providers prior termination behavior.

15. The system of claim 9, wherein operational intelligence data comprises a customer flow analysis report.

16. The system of claim 9, wherein operational intelligence data comprises a comparative analysis, wherein the comparative analysis comprises a comparison of the robustness of a single FX market-maker's market to the robustness of a larger FX market.

17. The system of claim 9, wherein operational intelligence data comprises a temporal analysis, wherein the temporal analysis comprises a comparison of the robustness of an FX during two or more different time periods.

18. The system of claim 1, wherein the data-obtaining module is configured to obtain raw data by performing at least one of:
sending an http file listing query to a log server;
performing an ETL dump of a reporting database; and
executing an http request under programmatic control.

19. A computer-implemented method for calculating realized spreads in financial transactions, comprising the following steps:
obtaining, via one or more processing units, one or more data files comprised of raw financial transaction data converting the raw financial data into normalized financial transaction data; and
generating one or more financial-trade metrics from the normalized financial data.

20. The method of claim 19, wherein the one or more financial-trade metrics comprises a realized spread, wherein the realized spread comprises at least one of:
subtracting an executed trade price from a forward offer;
subtracting a forward bid from the executed trade price;
subtracting the forward bid from the executed trade price;
subtracting the executed trade price from the forward bid;
subtracting the forward offer from the executed trade price;
subtracting the executed trade price from a midpoint between a bid and an offer; and
subtracting the midpoint between the bid and the offer from the executed trade price.

21. The method of claim 20, wherein the realized spread is calculated relative to a fixed time following the trade.

22. The method of claim 20, further comprising the steps of:
automatically adjusting a quoted spread based on the realized spread.

23. The method of claim 19, further comprising the steps of:
generating the one or more financial-trade metrics for one or more discrete lag times.

24. The method of claim 19, wherein one of the one or more financial-trade metrics comprises the prices available to the trader from a list of liquidity providers at a specific time.

25. The method of claim 19, wherein the one or more financial-trade metrics comprises effective spread.

26. The method of claim 19, further comprising the step of generating operational intelligence data.

27. The method of claim 26, wherein generating operational intelligence data comprises:
comparing actual trade with trade optimized for price across a different set of liquidity partners.

28. The method of claim 26, wherein generating operational intelligence data comprises:
calculating an actual profit or loss for a trade, wherein the trade has a known execution price;
determining an optimum price for the trade within a specified time period; and
generating an optimized profit or loss for the trade based on the known execution price and the optimum price.

29. The method of claim 26, wherein generating operational intelligence data comprises:
determining, based on the generated metrics, one or more conditions under which profit may arise from acting as an execution intermediary between one or more liquidity providers and one or more traders; and
generating a potential profit margin, based on the generated metrics, from acting as an execution intermediary between the one or more liquidity providers and the one or more traders.

30. The method of claim 26, wherein operational intelligence data comprises at least one of:
an actual order-fill ratio;
a potential order-fill ratio; and
a comparison of the actual order-fill ratio and the potential order-fill ratio.

31. The method of claim 26, wherein generating operational intelligence data comprises termination likelihood information, wherein the termination likelihood information comprises an estimate of the likelihood one or more of the one or more liquidity providers will terminate transactions with the trader, based on a trader's prior trades and one or liquidity providers prior termination behavior.

32. The method of claim 26, wherein operational intelligence data comprises a customer flow analysis report.

33. The method of claim 26, wherein operational intelligence data comprises a comparative analysis, wherein the comparative analysis comprises a comparison of the robustness of a single FX market-maker's market to the robustness of a larger FX market.

34. The method of claim 26, wherein operational intelligence data comprises a temporal analysis, wherein the temporal analysis comprises a comparison of the robustness of an FX during two or more different time periods.18

35. The method of claim 19, further comprising the steps of checking the data for errors.

36. The method of claim 19, further comprising the steps of:
checking the data for outliers; and
at least one of:
discarding the outliers;
flagging the outliers.

37. The method of claim 19, wherein obtaining raw financial-trade data consists of at least one of:
sending an http file listing query to a log server;
performing an ETL dump of a reporting database; and
executing an http request under programmatic control.

38. A non-transitory computer-readable medium comprising executable instructions that when executed by one or more processing units cause the one or more processing units to carry out a method comprising:
obtaining, via one or more processing units, one or more data files comprised of raw financial transaction data
converting the raw financial data into normalized financial transaction data; and
generating one or more financial-trade metrics from the normalized financial data.

39. The non-transitory computer-readable medium of claim 37, wherein the one or more financial-trade metrics comprises a realized spread, wherein the realized spread comprises at least one of:
subtracting an executed trade price from a forward offer;
subtracting a forward bid from the executed trade price;
subtracting the forward bid from the executed trade price;
subtracting the executed trade price from the forward bid;
subtracting the forward offer from the executed trade price;
subtracting the executed trade price from a midpoint between a bid and an offer; and
subtracting the midpoint between the bid and the offer from the executed trade price.

40. The non-transitory computer-readable medium of claim 38, wherein the realized spread is calculated relative to a fixed time following the trade.

41. The non-transitory computer-readable medium of claim 37, wherein the method further comprising the step of:
automatically adjusting a quoted spread based on the realized spread.
